(19) United States
(12) Patent Application Publication
(10) Pub. No.: US 2011/0126117 A1
(43) Pub. Date: May 26, 2011

(54) REMOTE COMPUTER CONTROL DEVICE USING VEHICLE TERMINAL AND METHOD THEREOF

(75) Inventors: Jang Woon PAEK, Daegu (KR); Jae Young KIM, Daegu (KR); Gwang Su KIM, Daejeon (KR)

(73) Assignee: Electronics and Telecommunications Research Institute, Daejeon (KR)

(21) Appl. No.: 12/786,041

(22) Filed: May 24, 2010

(30) Foreign Application Priority Data
Nov. 24, 2009 (KR) 10-2009-0114086

(51) Int. Cl. G06F 3/01; G06F 15/16

(52) U.S. Cl. 715/740; 709/228

(57) ABSTRACT

A remote computer control device that controls a remote computer, using a vehicle terminal, receives control information and a connection request including connection information from the terminal, and connects with the terminal on the basis of the connection information. Further, the remote computer control device controls the remote computer on the basis of the control information, and converts the control result to correspond to the size of the picture of the terminal and provides it to the terminal.

### CROSS-REFERENCE TO RELATED APPLICATION

This application claims priority to and the benefit of Korean Patent Application No. 10-2009-0114086 filed in the Korean Intellectual Property Office on Nov. 24, 2009, the entire contents of which are incorporated herein by reference.

### BACKGROUND OF THE INVENTION

(a) Field of the Invention

The present invention relates to a remote computer control device and a method thereof, using a vehicle terminal. In particular, the present invention relates to a device that connects with and controls a remote computer and a method thereof, using a vehicle terminal, under a Telematics environment.

(b) Description of the Related Art

A remote desktop connection method is used to connect with a remote computer such as a personal computer (PC) to perform desired work, using a device connecting with the Internet. However, when users using a remote desktop connection method cannot use the Internet, they have to find a place where they can use the Internet, such as an internet cafe. Further, although users can try to connect with a remote desktop using their notebook, it is difficult to use the notebook for a long time because it is difficult to carry the notebook and the life of the battery is short.

A remote PC control method using a mobile phone has been proposed to overcome these problems. However, it is difficult to expect high quality service in wireless communication for mobile phones because the delay time in remote PC control is too long. Further, according to a remote PC control method using mobile phones, it is uncomfortable to see pictures of PCs from the liquid crystal displays of mobile phones because the size of the liquid crystal displays of most mobile phones is generally not more than 3 inches.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a device and a method having advantages of allowing a user to easily connect with or control a remote computer using a vehicle terminal.

An embodiment of the present invention provides a method of controlling a remote computer including a remote connection server that includes: receiving a connection request including connection information of the remote connection server from a vehicle terminal; connecting with the terminal on the basis of the connection information and receiving control information inputted by a user through the terminal; and controlling the remote computer on the basis of the control information, converting the control result to fit the size of the picture of the terminal, and providing the converted result to the terminal.

Another embodiment of the present invention provides a method of controlling a remote computer by using a vehicle terminal, which includes: sending a request for connection with the remote computer by the terminal; receiving control information from a user by the terminal when connection with the remote computer is permitted; transmitting the control information to the remote computer and receiving the result of controlling the remote computer on the basis of the control information and providing the result to the user.

Another embodiment of the present invention provides a remote computer control device using a vehicle terminal, which includes: a transmitting/receiving unit that receives control information and a connection request including connection information from the terminal; and a control unit that connects with the terminal on the basis of the connection information and controls the remote computer on the basis of the control information, in which the transmitting/receiving unit transmits the results of controlling the remote computer to the terminal.

### BRIEF DESCRIPTION OF THE DRAWINGS

FIG. 1 is a view illustrating a remote connection environment that uses a remote computer control device using a vehicle terminal according to an exemplary embodiment of the present invention;

FIG. 2 is a block diagram illustrating a remote computer control device according to an exemplary embodiment of the present invention;

FIG. 3 is a flowchart illustrating a remote computer control method in a vehicle terminal according to an exemplary embodiment of the present invention; and

FIG. 4 is a flowchart illustrating a remote computer control method in a remote connection server according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

Hereinafter, a remote computer control device and a method thereof using a vehicle terminal according to an exemplary embodiment of the present invention are described in detail with reference to the accompanying drawings.

First, a vehicle terminal according to an exemplary embodiment of the present invention may be a device such as a navigation device, and is not limited thereto.

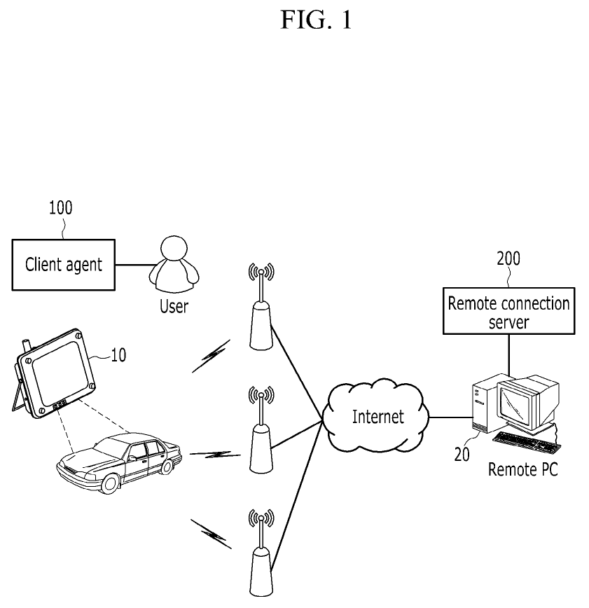

FIG. 1 is a view illustrating a remote connection environment that uses a remote computer control device using a vehicle terminal according to an exemplary embodiment of the present invention.

First, a remote connection environment according to an exemplary embodiment of the present invention is a Telematics environment that allows internet connection by using a wireless broadband (hereafter referred to as “Wibro”) communication module or a high speed downlink packet access (hereafter referred to as “HSDPA”) communication module equipped in vehicles. Users can connect with remote computers and conduct desired business using a terminal in vehicles under the remote connection environment. Hereinafter, in an embodiment of the present invention, a remote personal computer (PC) is used as a remote computer, but the present invention is not restricted to thereto.

Referring to FIG. 1, a remote computer control device (hereinafter, it is called “a remote PC control device”) includes a client agent 100 in a vehicle terminal 10, and a remote connection server 200 in a remote PC 20. The remote control device is connected with the remote PC 20 through the internet. Further, the remote PC control device can be applied to the vehicle terminal 10 (e.g., a navigation terminal), but is not limited thereto.

The client agent 100 is connected with the remote PC 20 by transmitting connection information received from a user to the remote connection server 200, and displays a stream received from the remote PC 20. The connection information described above includes the IP address of the remote PC 20 and the user's ID, password, etc.

In detail, the client agent 100 provides the user with a graphic user interface (hereafter referred to as “GUI”) for connection with the remote PC 20. The graphic user interface is an environment that allows the user to use graphics in order to conduct an operation when exchanging information with the remote PC 20. The user can input control information using an input unit provided by the client agent 100, or select a menu on the picture. The input unit includes a wireless keyboard, a wireless mouse, a touchpad, etc.

The user connects with the remote PC 20 using the client agent 100.

When permitted to connect with the remote PC 20, the client agent 100 displays a stream received from the remote PC 20, that is, a picture of the remote PC 20. Then, the user inputs control information for controlling the picture of the remote PC 20, which is displayed in the client agent 100, using the input unit.

The remote connection server 200 determines whether to permit connection with the client agent 100 in response to the received connection information, and then controls the remote PC 20 in response to control information when permitting the connection with the client agent 100.

In detail, the remote connection server 200 determines whether to permit connection of the user on the basis of the received connection information.

When permitting connection, the remote connection server 200 changes the size of the current picture of the remote PC 20 to fit the size of the picture of the vehicle terminal 10, and then transmits the picture with the changed size to the remote PC control device. Thereafter, the remote connection server 200 receives the user's control information through the client agent 100. The remote connection server 200 converts the control information to correspond to the size of the picture of the remote PC 20, and controls the remote PC 20 on the basis of the control information. Further, the remote connection server 200 converts the result of controlling the remote PC 20 to correspond to the size of the picture of the vehicle terminal 10 and transmits it to the client agent 100.

The remote connection server 200 according to an exemplary embodiment of the present invention can perform a compression function to correspond to the bandwidth of the wireless network, but is not limited thereto.

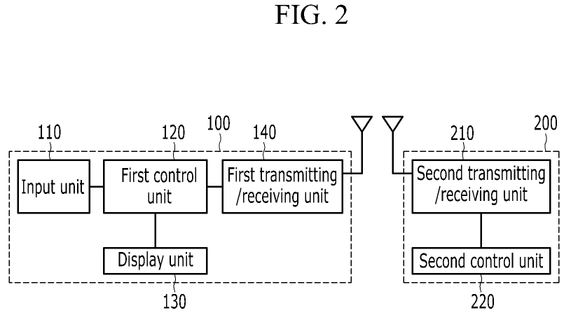

Next, the configuration of the remote PC control device is described in detail with reference to FIG. 2.

FIG. 2 is a block diagram illustrating a remote PC control device according to an exemplary embodiment of the present invention.

Referring to FIG. 2, the client agent 100 includes an input unit 110, a first control unit 120, a display unit 130, and a first transmitting/receiving unit 140.

The input unit 110 includes input units such as a touchpad, a keyboard, and a mouse, which allow the user to input connection information and control information. The connection information described above includes the IP address of the remote PC 20 and the user's ID, password, etc. Further, the control information is information that makes it possible to control the remote PC 20 using the input unit, that is, information when the user selects the menu on the picture of the vehicle terminal 10. The picture of the vehicle terminal 10 described above is a picture that is changed from the picture of the remote PC 20 to fit the size of the picture of the vehicle terminal 10 by the remote connection server 200.

The first control unit 120 connects with the remote PC 20 on the basis of the connection information received from the user.

The display unit 130 displays the information that the user inputs, and provides the user with the picture of the remote PC 20.

The first transmitting/receiving unit 140 is implemented as a type of information transmitting/receiving module that makes it possible to connect with the remote PC 20 through the internet. The information transmitting/receiving module described above is a mobile communication module, such as a Wibro module and an HSDPA module.

The remote connection server 200 includes a second transmitting/receiving unit 210 and a second control unit 220.

The second transmitting/receiving unit 210 receives connection information and control information inputted by the user from the client agent 100, and transmits the result or controlling the remote PC 20 to the client agent 100. For this operation, the second transmitting/receiving unit 210 is implemented in a type of network module supporting a wired or wireless internet connection. The network module described above includes at least one of a LAN card, a wireless local area network (WLAN) module, a Wibro module, and an HSDPA module.

The second control unit 220 controls the remote PC 20 in response to the received connection information or control information, and then converts the control result to fit the size of the picture of the vehicle terminal.

In detail, the second control unit 220 determines whether to permit connection of a user on the basis of the received connection information, and then changes the current picture of the remote PC 20 to fit the size of the picture of the vehicle terminal 10. Thereafter, the second control unit 220 transmits the current picture of the remote PC 20 to the client agent 100 in order to allow the user to input control information for controlling the remote PC 20.

The second control unit 220 controls the remote PC 20 on the basis of the control information received from the user and converts the control result to fit the size of the picture of the vehicle terminal 10. Thereafter, the second control unit 220 transmits the result converted to fit the size of the picture of the vehicle terminal 10 to the client agent 100 through the second transmitting/receiving unit 210.

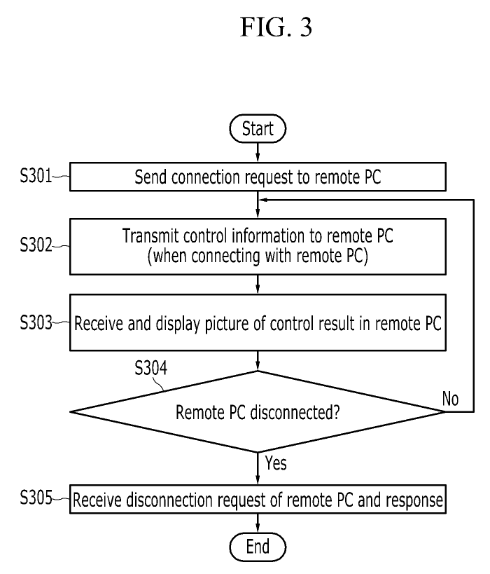

Next, a method of remote controlling a PC by the client agent 100 is described in detail with reference to FIG. 3.

FIG. 3 is a flowchart illustrating a remote PC control method in a vehicle terminal according to an exemplary embodiment of the present invention.

First, the remote PC control device includes a client agent 100 provided in a vehicle terminal 10 and a remote connection server 200 provided in a remote PC 20.

Referring to FIG. 3 the client agent 100 in the vehicle terminal 10 provides a user with the GUI and requests connection to the remote PC 20, using connection information inputted through the GUI (S301). The connection information described above includes the IP address of the remote PC 20 and the user's ID, password, etc.

When connection with the remote PC 20 is permitted, the client agent 100 displays a picture received from the remote PC 20. The received picture is a picture that is converted from the current picture of the remote PC 20 to fit the size of the vehicle terminal 10.

Thereafter, the client agent 100 transmits control information inputted by the user to the remote PC 20 (S302). The user inputs control information using an input unit provided by the client agent 100, or selects a menu in the picture. The input unit described above includes a wireless keyboard, a wireless mouse, a touchpad, etc.

The client agent 100 receives and displays the result of controlling the remote PC 20 on the basis of the transmitted control information, that is, the picture (S303). The picture described above is a picture converted from the result of controlling the remote PC 20 to fit the size of the picture of the vehicle terminal 10.

The user is provided with a picture corresponding to the control information inputted thereby, and determines whether to keep controlling the remote PC 20 and notifies the client agent 100 of the determination.

The client agent 100 determines whether to cut the connection with the remote PC 20, in accordance with the user's determination (S304). When the user wants to cut the connection with the remote PC 20, the client agent 100 sends a request for disconnection to the remote PC 20, receives a response corresponding to the request, and then cuts the connection (S305).

When the user does not want to cut the connection with the remote PC 20, the client agent 100 controls the remote PC 20 by transmitting the control information inputted by the user to the remote PC 20.

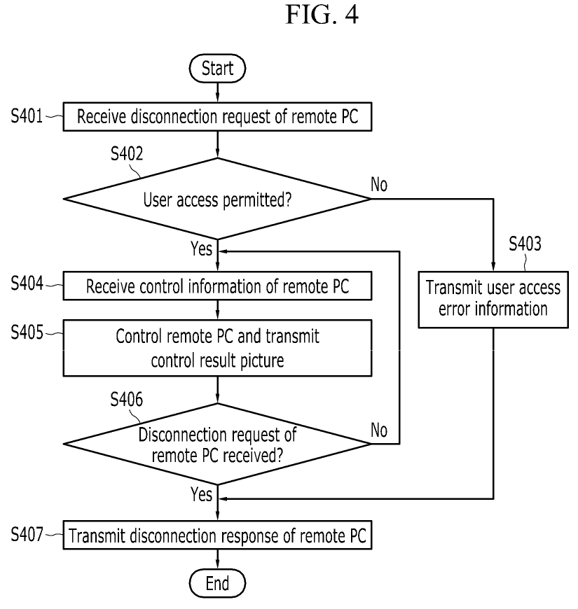

Next, a method of remotely controlling a PC by the remote connection server 200 included in the remote PC 20 is described in detail with reference to FIG. 4.

FIG. 4 is a flowchart illustrating a remote PC control method in a remote connection server according to an exemplary embodiment of the present invention.

First, the remote PC control device includes a client agent 100 provided in a vehicle terminal 10 and a remote connection server 200 provided in a remote PC 20.

Referring to FIG. 4, the remote connection server 200 receives a request for connection with the remote PC 20 from the client agent 100 included in the vehicle terminal 10 (S501). In this process, the remote connection server 200 receives connection information inputted by a user. The connection information described above includes the IP address of the remote PC 20 and the user's ID, password, etc.

The remote connection server 200 determines whether to permit connection with the client agent 100 in accordance with the received connection information (S402).

When not permitting the connection with the client agent 100, the remote connection server 200 determines that there is an error in the connection information inputted by the user, and transmits error information to the client agent 100 (S403).

When permitting the connection with the client agent 100, the remote connection server 200 receives control information for the remote PC 20 that is inputted by the user (S404). In this process, the user inputs the control information for the remote PC 20 by selecting a menu in a picture using an input unit provided by the client agent 100.

The remote connection server 200 controls the remote PC 20 on the basis of the received control information, and then transmits the control result, that is, a picture converted from the above referenced picture to fit the size of the picture of the vehicle terminal 10, to the client agent 100 (S405).

Then, the user is provided with a picture corresponding to the control information inputted thereby through the vehicle terminal including the client agent 100. Further, the user determines whether to keep controlling the remote PC 20 and then notifies the remote connection server 200 of the determination, through the client agent 100.

The remote connection server 200 determines whether the user has requested the client agent 100 to cut the connection with the remote PC 20 (S406).

When the user does not want to cut the connection with the remote PC 20, the remote connection server 200 receives control information for the remote PC 20 that has been inputted by the user. On the contrary, when the user wants to cut the connection with the remote PC 20, the remote connection server 200 notifies the client agent 100 of disconnection between the vehicle terminal 10 and the remote PC 20 by transmitting a response corresponding to the request for cutting the connection to the client agent 100 (S407).

According to an exemplary embodiment of the present invention, a remote computer control device using a vehicle terminal, i.e. a navigation device, makes it possible to easily connect with a remote computer and conduct desired business in a vehicle, without being restricted by a battery.

Further, according to an exemplary embodiment of the present invention, a remote computer control device makes it possible to improve the service quality by using wireless high speed internet and provide the picture of the computer to a user, using a display of about 7 inches, thereby being easily used by a user.

The above-mentioned exemplary embodiments of the present invention are not embodied only by an apparatus and method. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of controlling a remote computer including a remote connection server, the method comprising:
receiving a connection request including connection information by the remote connection server from a vehicle terminal;
connecting with the terminal on the basis of the connection information and receiving control information inputted by a user through the terminal; and
controlling the remote computer on the basis of the control information, converting the control result to fit the size of the picture of the terminal, and providing the converted result to the terminal.

2. The method of claim 1, wherein the connection information includes at least one of the IP address of the remote computer and the user's ID and password.

3. The method of claim 1, wherein the receiving of control information is receiving control information inputted by the user using an input unit provided by the terminal, from the terminal.

4. The method of claim 1, wherein providing the converted result to the terminal is compressing and providing the control result corresponding to the bandwidth of a network with the terminal to the terminal.

5. A method of controlling a remote computer by using a vehicle terminal, the method comprising:
sending a request for connecting with the remote computer by the terminal;
receiving control information from a user by the terminal, when connection with the remote computer is permitted;
transmitting the control information to the remote computer; and
receiving the result of controlling the remote computer on the basis of the control information and providing the result to the user.

6. The method of claim 5, wherein the providing of the result to the user is receiving a result obtained by converting the result of controlling the remote computer to correspond to the size of the picture of the terminal, and providing the result to the user.

7. The method of claim 5, wherein the sending of a connection request further includes transmitting connection information to the remote computer by the user using at least one input unit of a touchpad, a keyboard, and a mouse.

8. The method of claim 7, wherein the connection information includes at least one of the IP address of the remote computer and the user's ID and password.

9. A remote computer control device using a vehicle terminal, comprising:
a transmitting/receiving unit that receives control information and a connection request including connection information from the terminal; and
a control unit that connects with the terminal on the basis of the connection information and controls the remote computer on the basis of the control information,
wherein the transmitting/receiving unit transmits the result of controlling the remote computer to the terminal.

10. The remote computer control device of claim 9, wherein the control unit converts the result of controlling the remote computer to fit the size of the picture of the terminal.

11. The remote computer control device of claim 9, wherein the terminal provides a user with a graphic user interface.

12. The remote computer control device of claim 11, wherein the transmitting/receiving unit receives the connection request and control information inputted to the terminal by the user, using the graphic user interface.

13. The remote computer control device of claim 9, wherein the connection information includes at least one of the IP address of the remote computer and the
user's ID and password.
